(19) United States
(12) Patent Application Publication
(10) Pub. No.: US 2023/0251041 A1
(43) Pub. Date: Aug. 10, 2023

(54) HEAT EXCHANGER

(71) Applicant: MITSUBISHI HEAVY INDUSTRIES, LTD., Tokyo (JP)

(72) Inventors: Nobuhide Hara, Tokyo (JP); Koichi Tanimoto, Tokyo (JP); Tadahiko Suzuta, Tokyo (JP); Hiroyuki Nakaharai, Tokyo (JP)

(73) Assignee: MITSUBISHI HEAVY INDUSTRIES, LTD., Tokyo (JP)

(21) Appl. No.: 18/162,966

(22) Filed: Feb. 1, 2023

(30) Foreign Application Priority Data
Feb. 4, 2022 (JP) 2022-016358

(51) Int. Cl. F28D 7/16; F28F 9/02; F28F 9/22

(52) U.S. Cl. CPC F28D 7/1607; F28F 9/02; F28F 9/22

(57) ABSTRACT

A heat exchanger includes a pipe main body forming a flow path to which a first fluid is supplied, a pair of partition plates defining a closed space, a plurality of heat transfer tubes, a supply portion configured to supply a second fluid into the closed space, a discharge portion configured to discharge the second fluid in the closed space, and a flow path forming portion forming a plurality of small flow path portions between the heat transfer tubes adjacent to each other. The second fluid flows between the plurality of heat transfer tubes in the closed space in a direction opposite to the flow direction of the first fluid. The plurality of small flow path portions are disposed at positions different from each other when viewed from a position where the discharge portion is disposed in an extension direction.

### BACKGROUND OF THE INVENTION

### Field of the Invention

The present disclosure relates to a heat exchanger.

Priority is claimed on Japanese Patent Application No. 2022-016358, filed on Feb. 4, 2022, the content of which is incorporated herein by reference.

### Description of Related Art

Some heat exchangers have a configuration including a pipe and a plurality of heat transfer tubes disposed in the pipe. The heat exchanger having such a configuration exchanges heat between a first fluid flowing inside the plurality of heat transfer tubes and a second fluid flowing outside the heat transfer tubes inside the pipe. For example, Patent Document 1 discloses a configuration in which heat transfer tubes are provided with fins. By providing the fins to the heat transfer tubes, a heat exchange efficiency between the first fluid flowing inside the heat transfer tubes and the second fluid flowing outside the heat transfer tubes is increased.

### CITATION LIST

### Patent Document

[Patent Document 1] Japanese Unexamined Patent Application, First Publication No. 2010-223520

### SUMMARY OF THE INVENTION

By the way, it is sometimes desired to reduce a size of the heat exchanger. In such a case, narrowing gaps between the plurality of heat transfer tubes disposed in the pipe reduces a flow path cross-sectional area of the second fluid flowing outside the heat transfer tubes. As a result, the heat exchange efficiency between the first fluid inside the heat transfer tubes and the second fluid outside the heat transfer tubes may decrease. Therefore, it is desired to increase the heat exchange efficiency between the first fluid inside the heat transfer tubes and the second fluid outside the heat transfer tubes even in a configuration in which the gaps between the plurality of heat transfer tubes are narrowed.

The present disclosure provides a heat exchanger capable of increasing a heat exchange efficiency between the first fluid inside the heat transfer tubes and the second fluid outside the heat transfer tubes.

A heat exchanger according to the present disclosure includes: a pipe main body forming a flow path to which a first fluid is supplied; a pair of partition plates that are spaced apart in an extension direction of the pipe main body, block part of the flow path in the extension direction, and define a closed space in part of the flow path; a plurality of heat transfer tubes that have a tubular shape with both ends open, extend in the extension direction to penetrate the pair of partition plates, and are disposed side by side at intervals; a supply portion configured to supply a second fluid from an outside of the pipe main body into the closed space; a discharge portion that is spaced apart from the supply portion in the extension direction and configured to discharge the second fluid in the closed space to the outside of the pipe main body; and a flow path forming portion that forms a plurality of small flow path portions between the heat transfer tubes that are adjacent to each other at closest positions in the plurality of heat transfer tubes, in which the second fluid flows between the plurality of heat transfer tubes in the closed space in a direction opposite to a flow direction of the first fluid, and the plurality of small flow path portions are disposed at positions different from each other when viewed from a position where the discharge portion is disposed in the extension direction.

According to the heat exchanger of the present disclosure, the heat exchange efficiency between the first fluid inside the heat transfer tubes and the second fluid outside the heat transfer tubes can be increased.

### BRIEF DESCRIPTION OF THE DRAWINGS

FIG. 1 is a view showing a schematic configuration of a heat exchanger according to an embodiment of the present disclosure.

FIG. 2 is a cross-sectional view showing an internal structure of the heat exchanger according to the first embodiment of the present disclosure.

FIG. 3 is a cross-sectional view taken along a line A-A in FIG. 1.

FIG. 4 is a cross-sectional view taken along a line B-B in FIG. 1.

FIG. 5 is an enlarged cross-sectional view showing a flow path forming portion of the heat exchanger.

FIG. 6 is a view showing a flow path forming portion of a heat exchanger according to a modification example of the first embodiment of the present disclosure.

FIG. 7 is a cross-sectional view perpendicular to a facing direction showing a flow path forming portion of a heat exchanger according to a second embodiment of the present disclosure.

FIG. 8 is a cross-sectional view showing an internal structure of a heat exchanger according to a third embodiment of the present disclosure.

### DETAILED DESCRIPTION OF THE INVENTION

Hereinafter, embodiments for implementing a heat exchanger according to the present disclosure will be described with reference to the accompanying drawings. However, the present disclosure is not limited to only these embodiments.

(Configuration of Heat Exchanger)

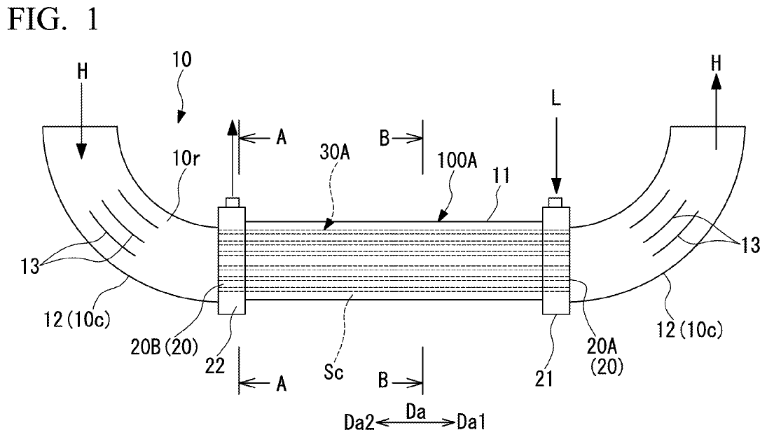

As shown in FIG. 1, a heat exchanger 100A is disposed in the middle of a pipe 10. The pipe 10 forms a flow path 10r through which a first fluid H flows. In the present embodiment, as the first fluid H, for example, a hydrogen gas flows through the flow path 10r in the pipe 10. In the present embodiment, the pipe 10 includes a straight pipe main body 11 and elbow portions 12 disposed at both end portions of the pipe main body 11. The elbow portion 12 forms a bent portion 10c of the flow path 10r. The elbow portion 12 is connected to the pipe main body 11. Inside the elbow portion 12, a plurality of vanes 13 are disposed for guiding a flow direction of the first fluid H to match the bent portion 10c. Each vane 13 is curved along a curve of the elbow portion 12. A plurality of the vanes 13 are disposed in the elbow portion 12 at intervals in a width direction of the flow path 10r. A disposition of the pipe main body 11 is not limited to being connected to a curved portion of the pipe 10 such as the elbow portion 12. The pipe main body 11 may be disposed as part of the pipe 10.

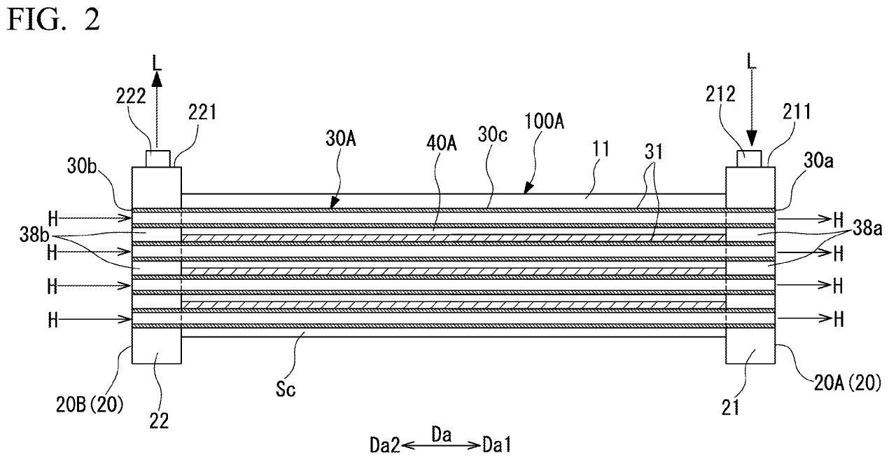

As shown in FIGS. 1 and 2, in the present embodiment, the heat exchanger 100A is installed at a position where the pipe main body 11 is disposed so as to form part of the pipe 10. The heat exchanger 100A includes the pipe main body 11 which forms an outer shell of the heat exchanger 100A, a pair of partition plates 20, a supply portion 21, a discharge portion 22, and a core portion 30A.

The pair of partition plates 20 are spaced apart in an extension direction Da which is a direction in which the pipe 10 extends. The pair of partition plates 20 are disposed at both ends of the pipe main body 11 in the extension direction Da. The pair of partition plates 20 include a first partition plate 20A disposed on one side (first side) Da1 of the extension direction Da with respect to the pipe main body 11, and a second partition plate 20B disposed on the other side (second side) Da2 of the extension direction Da with respect to the pipe main body 11. Here, the one side Da1 of the extension direction Da is a downstream side of a flow direction of the first fluid H inside the pipe main body 11. The other side Da2 of the extension direction Da is an upstream side of the flow direction of the first fluid H inside the pipe main body 11. The pair of partition plates 20 (the first partition plate 20A and the second partition plate 20B) each have a plate shape extending along a plane perpendicular to (intersecting with) the extension direction Da. The pair of partition plates 20 each block part of the flow path 10r in the extension direction Da. A closed space Sc defined by the first partition plate 20A and the second partition plate 20B is formed in part of the flow path 10r inside the pipe 10.

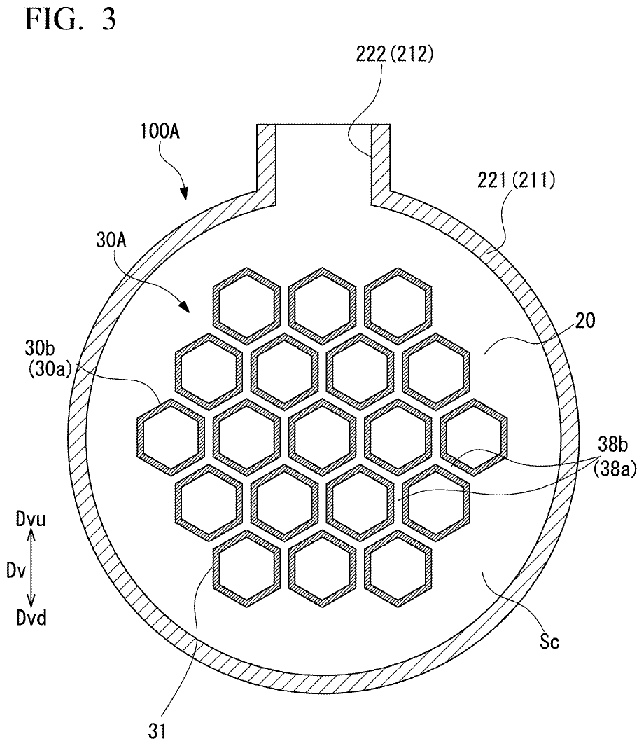

The supply portion 21 is disposed on the one side Da1 of the extension direction Da with respect to the pipe main body 11. The supply portion 21 is connected to the pipe main body 11 as an inlet-side header. The supply portion 21 is configured to supply a second fluid L introduced from the outside to the closed space Sc inside the pipe main body 11. As shown in FIG. 2, the supply portion 21 includes a cylindrical supply portion main body 211 that is open at both ends in the extension direction Da. An opening of the supply portion main body 211 on the one side Da1 of the extension direction Da is blocked by the first partition plate 20A. An opening of the supply portion main body 211 on the other side Da2 of the extension direction Da is connected to the inside of the pipe main body 11. A supply port 212 that connects the outside and the inside of the closed space Sc is formed in the supply portion main body 211 on the other side Da2 of the extension direction Da with respect to the first partition plate 20A. As shown in FIG. 3, the supply port 212 can supply the second fluid L into the closed space Sc from the outside.

The discharge portion 22 is disposed on the other side Da2 of the extension direction Da with respect to the pipe main body 11. The discharge portion 22 is connected to the pipe main body 11 as an outlet side header. The discharge portion 22 is configured to discharge the second fluid L from the closed space Sc inside the pipe main body 11 to the outside. The discharge portion 22 includes a cylindrical discharge portion main body 221 which is open at both ends in the extension direction Da. An opening of the discharge portion main body 221 on the other side Da2 of the extension direction Da is blocked by the second partition plate 20B. An opening of the discharge portion main body 221 on the one side Da1 of the extension direction Da is connected to the inside of the pipe main body 11. In the discharge portion main body 221, a discharge port 222 connecting the inside of the closed space Sc and the outside is formed on the one side Da1 of the extension direction Da with respect to the second partition plate 20B. As shown in FIG. 3, the discharge port 222 can discharge the second fluid L from the inside of the closed space Sc to the outside.

As shown in FIG. 2, the core portion 30A is disposed inside the pipe main body 11. A first end portion 30a of the core portion 30A on the one side Da1 of the extension direction Da is covered with the supply portion main body 211 from the outside. A second end portion 30b of the core portion 30A on the other side Da2 of the extension direction Da is covered with the discharge portion main body 221 from the outside. The core portion 30A includes a plurality of heat transfer tubes 31 and a flow path forming portion 40A.

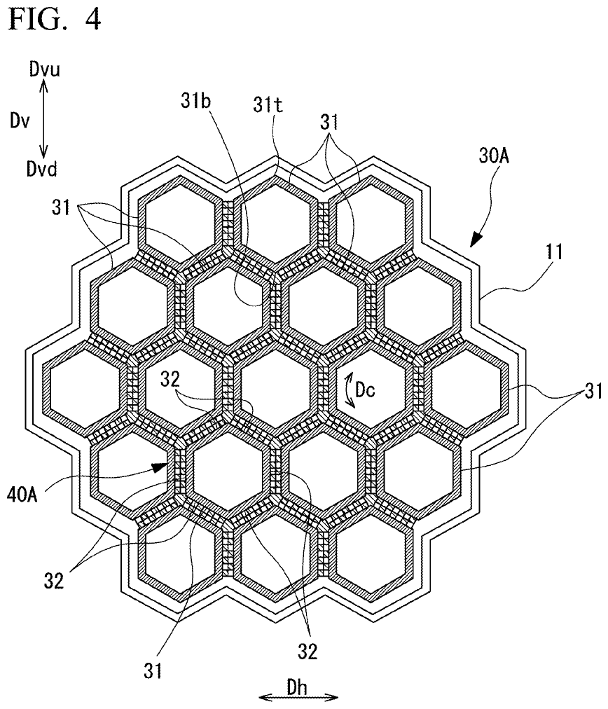

The plurality of heat transfer tubes 31 are disposed inside the pipe main body 11. The plurality of heat transfer tubes 31 each extend in the extension direction Da (direction perpendicular to a drawing sheet surface of FIG. 4). An end portion of each heat transfer tube 31 on the one side Da1 of the extension direction Da is disposed in the supply portion 21. An end portion of each heat transfer tube 31 on the other side Da2 of the extension direction Da is disposed in the discharge portion 22. Both ends of each heat transfer tube 31 in the extension direction Da are open. Both ends of each heat transfer tube 31 in the extension direction Da are disposed outside the pair of partition plates 20 in the extension direction Da so as to penetrate the pair of partition plates 20. Both ends of each heat transfer tube 31 are open at positions facing the elbow portions 12.

The plurality of heat transfer tubes 31 are arranged side by side at intervals in a direction orthogonal to (intersecting with) the extension direction Da inside the pipe main body 11. As shown in FIGS. 3 and 4, the plurality of heat transfer tubes 31 are disposed in multiple stages in a vertical direction Dv orthogonal to the extension direction Da when viewed from the extension direction Da. In each stage in the vertical direction Dv, a plurality of the heat transfer tubes 31 are disposed in a horizontal direction Dh orthogonal to the extension direction Da and the vertical direction Dv. Each of the vertical direction Dv and the horizontal direction Dh is one of radial directions in the pipe main body 11. The heat transfer tubes 31 in a stage positioned on an upward Dvu side in the vertical direction Dv and the heat transfer tubes 31 in a stage positioned on a downward Dvd side in the vertical direction Dv are disposed with their positions shifted in the horizontal direction Dh. The plurality of heat transfer tubes 31 are disposed in a honeycomb shape when viewed from the extension direction Da. The plurality of heat transfer tubes 31 are arranged such that central positions (central axes 31c) have a hexagonal shape as a whole when viewed from the extension direction Da.

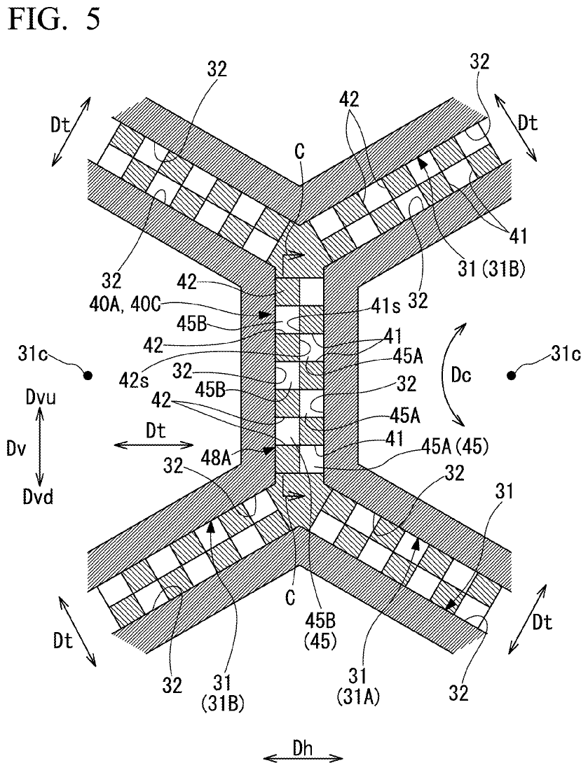

Each heat transfer tube 31 has, for example, a hexagonal cross-sectional shape along a plane orthogonal to the extension direction Da. That is, each heat transfer tube 31 has six outer surfaces 32 extending in a circumferential direction Dc of one heat transfer tube 31 when viewed from the extension direction Da. Each heat transfer tube 31 is disposed such that one top portion 31t faces upward Dvu in the vertical direction Dv and another top portion 31b faces downward Dvd in the vertical direction Dv. The plurality of heat transfer tubes 31 are disposed such that the outer surfaces 32 of adjacent heat transfer tubes 31 are parallel to each other. As shown in FIG. 5, the outer surfaces 32 of the heat transfer tubes 31 adjacent to each other in the horizontal direction Dh face each other with a gap in the horizontal direction Dh. The outer surfaces 32 of the heat transfer tubes 31 that are adjacent to each other in a diagonal direction that is inclined with respect to the vertical direction Dv face each other with a gap in the diagonal direction that intersects with the vertical direction Dv and the horizontal direction Dh. The gap between the outer surfaces 32 of two heat transfer tubes 31 adjacent to each other is constant when viewed from the extension direction Da. In the following description, a direction connecting the central axes 31c of the two heat transfer tubes 31 adjacent to each other at the closest positions is referred to as a facing direction Dt.

The flow path forming portion 40A forms a plurality of small flow path portions among the plurality of heat transfer tubes 31 that are adjacent to each other at the closest positions in an imaginary plane orthogonal to the extension direction Da in the plurality of heat transfer tubes 31. The flow path forming portion 40A includes a plurality of first protrusion portions 41 and a plurality of second protrusion portions 42.

The plurality of first protrusion portions 41 are formed on each outer surface 32 of one heat transfer tube (first heat transfer tube) 31A of the two heat transfer tubes 31A and 31B that are adjacent to each other at the closest positions. Each first protrusion portion 41 protrudes in the facing direction Dt from each outer surface 32 of the one heat transfer tube 31A toward the other heat transfer tube (second heat transfer tube) 31B. The plurality of first protrusion portions 41 are disposed at intervals in the circumferential direction Dc of each heat transfer tube 31 along each outer surface 32 of the one heat transfer tube 31A when viewed from the extension direction Da. That is, a plurality of the first protrusion portions 41 are formed on one outer surface 32. Each first protrusion portion 41 has a rectangular cross-sectional shape when viewed from the extension direction Da and extends in the extension direction Da.

The plurality of second protrusion portions 42 are formed on each outer surface 32 of the other heat transfer tube 31B of the two heat transfer tubes 31A and 31B adjacent to each other at the closest positions. Each second protrusion portion 42 protrudes in the facing direction Dt from each outer surface 32 of the other heat transfer tube 31B toward the one heat transfer tube 31A. The plurality of second protrusion portions 42 are disposed at intervals in the circumferential direction Dc of each heat transfer tube 31 along each outer surface 32 of the other heat transfer tube 31B when viewed from the extension direction Da. That is, a plurality of the second protrusion portions 42 are formed on one outer surface 32. Each second protrusion portion 42 has a rectangular cross-sectional shape when viewed from the extension direction Da and extends in the extension direction Da.

The first protrusion portion 41 and the second protrusion portion 42 are disposed to be shifted in the circumferential direction Dc when viewed from the extension direction Da. In the first protrusion portion 41 and the second protrusion portion 42, part of a tip 41s of the first protrusion portion 41 and part of a tip 42s of the second protrusion portion 42 that are adjacent to each other in the circumferential direction Dc are connected when viewed from the extension direction Da. Specifically, when viewed from the extension direction Da, in the first protrusion portion 41 and the second protrusion portion 42 each having a rectangular cross-sectional shape, a corner of the tip 41s of the first protrusion portion 41 and a corner of the tip 42s of the second protrusion portion 42 are connected.

The flow path forming portion 40A forms the plurality of small flow path portions 45 by the plurality of first protrusion portions 41 and the plurality of second protrusion portions 42. The plurality of small flow path portions 45 are formed between each outer surface 32 of the one heat transfer tube 31A and the other heat transfer tube 31B. The plurality of small flow path portions 45 include a first small flow path portion 45A and a second small flow path portion 45B.

The first small flow path portion 45A is a space surrounded by each outer surface 32 of the one heat transfer tube 31A and the tip 42s of the second protrusion portion 42 formed in the other heat transfer tube 31B between the first protrusion portions 41 which are adjacent to each other in the circumferential direction Dc. The first small flow path portion 45A is disposed at a position close to the one heat transfer tube 31A of the two heat transfer tubes 31A and 31B adjacent to each other at the closest positions among the plurality of heat transfer tube 31 in the facing direction Dt.

The second small flow path portion 45B is a space surrounded by each outer surface 32 of the other heat transfer tube 31B and the tip 41s of the first protrusion portion 41 formed in the one heat transfer tube 31A side between the second protrusion portions 42 which are adjacent to each other in the circumferential direction Dc. The second small flow path portion 45B is disposed at a position close to the other heat transfer tube 31B of the two heat transfer tubes 31A and 31B adjacent to each other at the closest positions among the plurality of heat transfer tube 31 in the facing direction Dt.

The plurality of first small flow path portions 45A and second small flow path portions 45B are disposed at positions different from each other when viewed from a position where the discharge portion 22 is disposed in the extension direction Da. The first small flow path portion 45A and the second small flow path portion 45B are disposed at positions different from each other in both the facing direction Dt and the circumferential direction Dc. In this manner, the first small flow path portion 45A and the second small flow path portion 45B are disposed in a zigzag pattern when viewed from the extension direction Da.

As shown in FIG. 2, such a flow path forming portion 40A is formed in part of the core portion 30A in the extension direction Da. The flow path forming portion 40A is formed only in a core intermediate portion 30c between a first end portion 30a on the one side Da1 of the extension direction Da and a second end portion 30b on the other side Da2 of the extension direction Da. The flow path forming portion 40A is formed in a part except for the supply portion 21 and the discharge portion 22 between the pair of partition plates 20. That is, in the core portion 30A, the plurality of small flow path portions 45 are not formed and gaps 38a and 38b are formed between the plurality of heat transfer tubes 31 at a first end portion 30a corresponding to the supply portion 21 and a second end portion 30b corresponding to the discharge portion 22 in the extension direction Da.

Each component of the heat exchanger 100A having a configuration described above is desirably formed by 3D printer technology represented by additive modeling (AM). Further, titanium alloys and stainless steel alloys (SUS) are preferably used as materials for forming the heat exchanger 100A.

In such a heat exchanger 100A, as shown in FIG. 1, the first fluid H flows through the flow path 10r in the pipe 10 from the other side Da2 toward the one side Da1 of the extension direction Da. The first fluid H that has flowed through the elbow portion 12 disposed on the other side Da2 of the extension direction Da with respect to the pipe main body 11 flows into the heat transfer tube 31. The first fluid H flows into each heat transfer tube 31 from an end of the heat transfer tube 31 that is open on the other side Da2 of the extension direction Da with respect to the second partition plate 20B. That is, the first fluid H does not flow into the closed space Sc on the one side Da1 of the extension direction Da with respect to the second partition plate 20B but flows only into the heat transfer tubes 31. The first fluid H flows through the plurality of heat transfer tubes 31 from the other side Da2 toward the one side Da1 of the extension direction Da. The first fluid H that has flowed through the heat transfer tubes 31 flows out to the elbow portion 12 disposed on the one side Da1 of the extension direction Da with respect to the pipe main body 11. The first fluid H that has flowed through the heat transfer tubes 31 flows out into the elbow portion 12 from an end of the heat transfer tube 31 that is open on the one side Da1 of the extension direction Da with respect to the first partition plate 20A.

As shown in FIG. 2, the second fluid L supplied from the outside of the heat exchanger 100A flows into the closed space Sc of the pipe main body 11 from the supply port 212 of the supply portion 21. The second fluid L is a liquid that cools the first fluid H to be cooled. The second fluid L is, for example, liquid oxygen. At the first end portion 30a of the core portion 30A disposed in the supply portion 21, the second fluid L flows from the gaps 38a formed between the plurality of heat transfer tubes 31 into portions between the plurality of heat transfer tubes 31 disposed in the closed space Sc. Specifically, the second fluid L flows into the plurality of small flow path portions 45 from the gaps 38a. The second fluid L flows through the plurality of small flow path portions 45 from the one side Da1 toward the other side Da2 of the extension direction Da. That is, the second fluid L flows in an opposite direction to the first fluid H in the extension direction Da. The second fluid L exchanges heat with the first fluid H flowing through the heat transfer tubes 31 while flowing through the small flow path portions 45, thereby cooling the first fluid H. The second fluid L reaches the gaps 38b of the second end portion 30b of the core portion 30A disposed in the discharge portion 22 from the plurality of small flow path portions 45. Thereafter, the second fluid L is discharged to the outside from the discharge port 222 of the discharge portion 22 and flows out from the closed space Sc.

(Operation and Effect)

In the heat exchanger 100A configured as described above, the plurality of small flow path portions 45 are formed by the flow path forming portion 40A between the heat transfer tubes 31 adjacent to each other at the closest positions among the plurality of heat transfer tubes 31. In addition, the plurality of small flow path portions 45 are disposed at positions different from each other when viewed from the position where the discharge portion 22 is disposed in the extension direction Da. Therefore, when the second fluid L flows through the plurality of small flow path portions 45, the second fluid L flows while being in contact with the flow path forming portion 40A that forms an inner surface of each small flow path portion 45. Thus, a contact surface area where the second fluid L comes into contact with the flow path forming portion 40A can be ensured largely between the heat transfer tubes 31 adjacent to each other at the closest positions. In addition, each small flow path portion 45 has a smaller cross-sectional area when viewed from the extension direction Da than a gap between the heat transfer tubes 31 adjacent to each other at the closest positions. Therefore, the flow velocity of the second fluid L flowed into the small flow path portion 45 increases. As a result, the second fluid L flows through the plurality of small flow path portions 45, thereby increasing the heat transfer efficiency compared to a case where the second fluid L flows through the gaps between the heat transfer tubes 31 in which the small flow path portions are not formed. Thus, the heat exchange efficiency between the first fluid H inside the heat transfer tube 31 and the second fluid L outside the heat transfer tube 31 can be increased.

In addition, the flow path forming portion 40A forms the first small flow path portion 45A disposed at a position close to the one heat transfer tube 31A and the second small flow path portion 45B disposed at a position close to the other heat transfer tube 31B. In particular, in the present embodiment, the first small flow path portion 45A and the second small flow path portion 45B are disposed with their positions shifted in the facing direction Dt and the circumferential direction Dc between the two heat transfer tubes 31 adjacent to each other. In this manner, the first small flow path portion 45A and the second small flow path portion 45B are disposed in a zigzag pattern when viewed from the extension direction Da. As a result, a cross-sectional area of each of the first small flow path portion 45A and the second small flow path portion 45B when viewed from the extension direction Da is small compared to a case where one small flow path portion 45 is formed between the heat transfer tubes 31 adjacent to each other at the closest positions. Therefore, the flow velocity of the second fluid L that has flowed into the first small flow path portion 45A and the second small flow path portion 45B further increases. Therefore, the heat transfer efficiency of the second fluid L via the flow path forming portion 40A increases as the second fluid L flows through the first small flow path portions 45A and the second small flow path portions 45B that are disposed in a zigzag pattern. As a result, the heat exchange efficiency between the first fluid H inside the heat transfer tube 31 and the second fluid L outside the heat transfer tube 31 can be further increased.

In addition, the flow path forming portion 40A includes the plurality of first protrusion portions 41 formed on the outer surface 32 of the one heat transfer tube 31A and the plurality of second protrusion portions 42 formed on the outer surface 32 of the other heat transfer tube 31B. Further, when viewed from the extension direction Da, each of the plurality of first protrusion portions 41 and each of the plurality of second protrusion portions 42 are disposed to be shifted in the circumferential direction Dc. As a result, a contact surface area where the second fluid L comes into contact with the flow path forming portion 40A can be ensured largely by the first protrusion portion 41 and the second protrusion portion 42 compared to a case where only any one of the first protrusion portion 41 and the second protrusion portion 42 is formed. As a result, the heat exchange efficiency between the first fluid H inside the heat transfer tube 31 and the second fluid L outside the heat transfer tube 31 can be further increased.

Also, when viewed from the extension direction Da, part of the tip 41s of the each of the plurality of first protrusion portions 41 and part of the tip 42s of the each of the plurality of second protrusion portions 42 that are adjacent to each other in the circumferential direction Dc are connected. Thus, the first small flow path portion 45A and the second small flow path portion 45B can be formed independently of each other. Therefore, the cross-sectional area when viewed from the extension direction Da can be made small compared to a case where the first small flow path portion 45A and the second small flow path portion 45B are connected. Thus, it is possible to further increase the flow velocity of the second fluid L that has flowed into the first small flow path portion 45A and the second small flow path portion 45B.

### Modification Example of First Embodiment

In the above-described first embodiment, when viewed from the extension direction Da, part of the tip 41s of the first protrusion portion 41 and part of the tip 42s of the second protrusion portion 42 that are adjacent to each other in the circumferential direction Dc are connected, but a structure of the flow path forming portion 40A is not limited to such a structure.

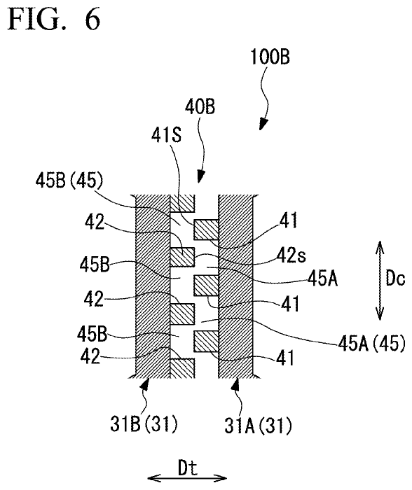

For example, as shown in FIG. 6, in the flow path forming portion 40B of a heat exchanger 100B, when viewed from the extension direction Da, the each of the plurality of first protrusion portions 41 and the each of the plurality of second protrusion portions 42 adjacent to each other in the circumferential direction Dc may be spaced apart in the circumferential direction Dc.

According to such a configuration, the first small flow path portion 45A formed between the first protrusion portions 41 adjacent to each other in the circumferential direction Dc communicates with the second small flow path portion 45B formed between the first protrusion portions 41 adjacent to each other in the circumferential direction Dc. Even in such a configuration, the heat exchange efficiency of the second fluid L via the flow path forming portion 40A increases as the second fluid L passes through a plurality of the first small flow path portions 45A and the second small flow path portions 45B. Moreover, since the first protrusion portion 41 and the second protrusion portion 42 are independent, the first protrusion portion 41 and the second protrusion portion 42 are easily formed.

### Second Embodiment

Next, a second embodiment of the heat exchanger according to the present disclosure will be described. In addition, in the second embodiment described below, the same reference numerals are given to the configurations common to the above-described first embodiment in the drawings, and the description thereof will be omitted. In the second embodiment, a configuration of part of a flow path forming portion 40C is different from that of the first embodiment.

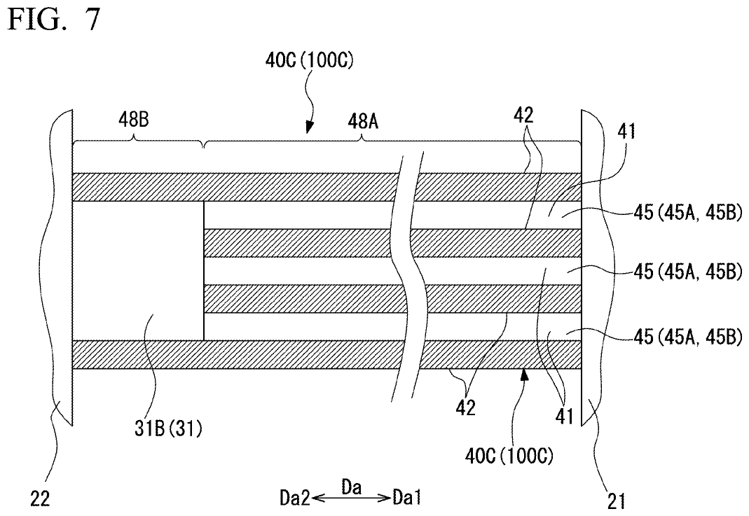

As shown in FIG. 7, the flow path forming portion 40C of a heat exchanger 100C is formed such that the flow path cross-sectional area of the small flow path portion when view from the extension direction Da is larger at a position close to the discharge portion 22 than at a position close to the supply portion 21 in the extension direction Da. The flow path forming portion 40C includes a first flow path region 48A and a second flow path region 48B. The first flow path region 48A is formed in a partial region on the one side Da1 of the extension direction Da in the flow path forming portion 40C. The second flow path region 48B is formed in a partial region on the other side Da2 of the extension direction Da with respect to the first flow path region 48A in the flow path forming portion 40C. The second flow path region 48B is formed to have a flow path cross-sectional area when viewed from the extension direction Da larger than that of the first flow path region 48A.

In the first flow path region 48A, as in the flow path forming portion 40A in the first embodiment, as shown in FIG. 5, a plurality of the small flow path portions 45 are formed between the heat transfer tubes 31 adjacent to each other at the closest positions. In other words, the plurality of first protrusion portions 41 and the plurality of second protrusion portions 42 are disposed in the first flow path region 48A. Thus, the plurality of small flow path portions 45 include the first small flow path portion 45A and the second small flow path portion 45B.

At least some of the plurality of first protrusion portions 41 and the plurality of second protrusion portions 42 terminate at a position on the one side Da1 of the extension direction Da with respect to the second flow path region 48B. That is, at least some of the plurality of first protrusion portions 41 and the plurality of second protrusion portions 42 are not formed in the second flow path region 48B. All of the plurality of first protrusion portions 41 and the plurality of second protrusion portions 42 may not be formed in the second flow path region 48B. As a result, at least some of the plurality of small flow path portions 45 (the first small flow path portion 45A and the second small flow path portion 45B) formed in the first flow path region 48A merge with the second flow path region 48B. Therefore, the flow path forming portion 40C is formed to have a flow path cross-sectional area larger than the small flow path portion 45 when view from the extension direction Da at a position close to the discharge portion 22 than at a position close to the supply portion 21 in the extension direction Da.

According to the heat exchanger 100C configured as described above, when a temperature of the first fluid H is higher than a temperature of the second fluid L, the temperature of the second fluid L flowing between the plurality of heat transfer tubes 31 increases due to the heat exchange with the first fluid H passing through the plurality of heat transfer tubes 31. As a result, a property of the second fluid L approaches a gas from a liquid. Thus, a density of the second fluid L may decrease to increase (expand) a specific volume thereof as the second fluid L approaches the discharge portion 22 in the extension direction Da. On the other hand, in the flow path forming portion 40C of the second embodiment, the first flow path region 48A is changed to the second flow path region 48B at a position close to the discharge portion 22. As a result, the flow path cross-sectional area of the small flow path portion 45 when viewed from the extension direction Da in the second flow path region 48B can be increased. Thus, a volume expansion of the second fluid L that has flowed from the first flow path region 48A into the second flow path region 48B can be allowed, and the flow velocity of the second fluid L can be increased in the second flow path region 48B. As a result, the heat exchange efficiency between the first fluid H inside the heat transfer tube 31 and the second fluid L outside the heat transfer tube 31 can be increased.

Further, the second flow path region 48B is formed by merging at least some of the plurality of small flow path portions 45 formed in the first flow path region 48A. Thus, it is possible to easily form a structure in which the flow path cross-sectional area is increased in the middle of the extension direction Da.

### Third Embodiment

Next, a third embodiment of the heat exchanger according to the present disclosure will be described. In addition, in the third embodiment described below, the same reference numerals are given to the configurations common to the above-described first embodiment and second embodiment in the drawings, and the description thereof will be omitted. In the third embodiment, a configuration of a flow path forming portion 40D is different from that of the first embodiment and the second embodiment.

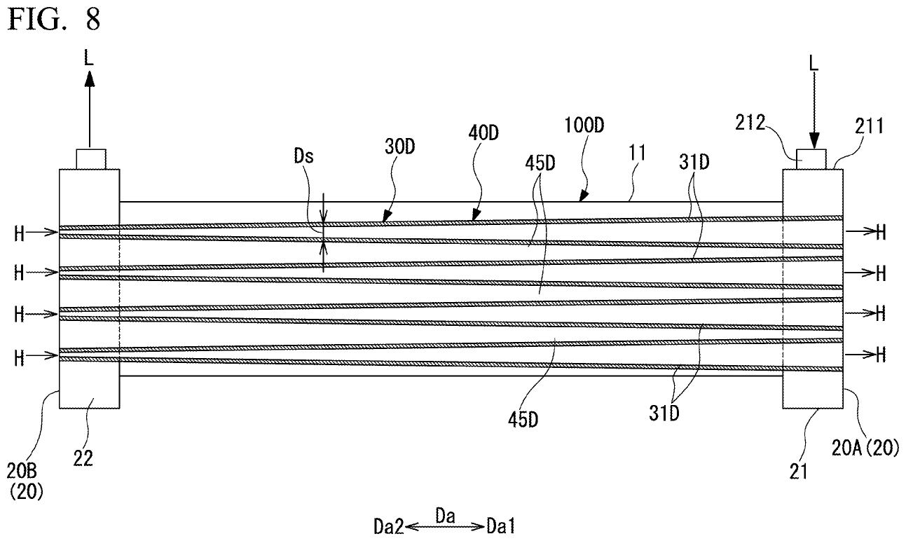

As shown in FIG. 8, a core portion 30D of a heat exchanger 100D includes a plurality of heat transfer tubes 31D and a flow path forming portion 40D.

A flow path cross-sectional area in each heat transfer tube 31D is formed so as to gradually increase from the other side Da2 toward the one side Da1 in the extension direction Da. Therefore, a tube diameter (inner diameter and outer diameter) Ds of each heat transfer tube 31D is formed so as to gradually increase from the other side Da2 toward the one side Da1 of the extension direction Da. In other words, the heat transfer tube 31D is a tube member having a trapezoidal cross section in which the one side Da1 is wider than the other side Da2 of the extension direction Da. Accordingly, a cross-sectional area of a gap (a portion where the flow path forming portion 40D is formed) between the heat transfer tubes 31D adjacent to each other at the closest positions in an imaginary plane orthogonal to the extension direction Da is gradually increases from the one side Da1 toward the other side Da2 of the extension direction Da. In the third embodiment, the gap becomes a small flow path portion 45D. In other words, the flow path forming portion 40D of the third embodiment has a structure that is combined with a wall surface of the heat transfer tube 31D. As a result, a plurality of the small flow path portions 45D have a flow path cross-sectional area when viewed from the extension direction Da that gradually increases from the supply portion 21 toward the discharge portion 22 in the extension direction Da.

According to such a configuration, the small flow path portion 45D serving as a flow path for the second fluid L has a flow path cross-sectional area that gradually increases from the one side Da1 toward the other side Da2 of the extension direction Da. Therefore, an increase in volume of the second fluid L can be allowed, and the flow velocity of the second fluid L can be gradually increased. As a result, the heat exchange efficiency between the first fluid H inside the heat transfer tube 31 and the second fluid L outside the heat transfer tube 31 can be increased.

### Other Embodiments

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

In each of the above-described embodiments, the first small flow path portion 45A and the second small flow path portion 45B are disposed in a zigzag pattern at different positions in both the facing direction Dt and the circumferential direction Dc. However, the small flow path portion 45 is not limited to such a structure. The disposition of the small flow path portion 45 is not limited in any way, and by providing the plurality of small flow path portions 45 having narrowed flow path cross-sectional areas, it is possible to obtain the same operations and effects as those of the above embodiments.

<Appendix>

The heat exchangers 100A to 100D described in the respective embodiments are understood as follows, for example.

(1) A heat exchanger 100A to 100D according to a first aspect includes: a pipe main body 11 forming a flow path 10r to which a first fluid H is supplied; a pair of partition plates 20 that are spaced apart in an extension direction Da of the pipe main body 11, block part of the flow path 10r in the extension direction Da, and define a closed space Sc in part of the flow path 10r; a plurality of heat transfer tubes 31 and 31D that have a tubular shape with both ends open, extend in the extension direction Da to penetrate the pair of partition plates 20, and are disposed side by side at intervals; a supply portion 21 configured to supply a second fluid L from an outside of the pipe main body 11 into the closed space Sc; a discharge portion 22 that is spaced apart from the supply portion 21 in the extension direction Da and configured to discharge the second fluid L in the closed space Sc to the outside of the pipe main body 11; and a flow path forming portion 40A to 40D that forms a plurality of small flow path portions 45 between the plurality of heat transfer tubes 31 and 31D that are adjacent to each other at closest positions in the plurality of heat transfer tubes 31 and 31D, in which the second fluid L flows between the plurality of heat transfer tubes 31 and 31D in the closed space Sc in a direction opposite to a flow direction of the first fluid H, and the plurality of small flow path portions 45 are disposed at positions different from each other when viewed from a position where the discharge portion 22 is disposed in the extension direction Da.

According to such heat exchangers 100A to 100D, when the second fluid L flows through the plurality of small flow path portions 45, the second fluid L flows while being in contact with the flow path forming portion 40A that forms an inner surface of each small flow path portion 45. Thus, a contact surface area where the second fluid L comes into contact with the flow path forming portion 40A can be ensured largely between the heat transfer tubes 31 adjacent to each other at the closest positions. In addition, each small flow path portion 45 has a smaller cross-sectional area when viewed from the extension direction Da than a gap between the heat transfer tubes 31 adjacent to each other at the closest positions. Therefore, a flow velocity of the second fluid L that has flowed into the small flow path portion 45 increases. As a result, the second fluid L flows through the plurality of small flow path portions 45, thereby increasing the heat transfer efficiency compared to a case where the second fluid L flows through the gaps between the heat transfer tubes 31 in which the small flow path portions 45 are not formed. Thus, the heat exchange efficiency between the first fluid H inside the heat transfer tube 31 and the second fluid L outside the heat transfer tube 31 can be increased.

(2) A heat exchanger 100A to 100D according to a second aspect is the heat exchanger 100A to 100D described in (1), in which the flow path forming portion 40A to 40D forms, as the small flow path portions 45, a first small flow path portion 45A disposed at a position close to one heat transfer tube 31 and 31D of two heat transfer tubes 31 and 31D adjacent to each other at the closest positions among the plurality of heat transfer tubes 31, and a second small flow path portion 45B disposed at a position close to the other heat transfer tube 31 and 31D of the two heat transfer tubes 31 and 31D adjacent to each other at the closest positions and disposed at a position shifted in a circumferential direction Dc of the plurality of heat transfer tubes 31 and 31D with respect to the first small flow path portion 45A when viewed from the extension direction Da.

Thus, a cross-sectional area of each of the first small flow path portion 45A and the second small flow path portion 45B when viewed from the extension direction Da is small compared to a case where one small flow path portion 45 is formed between the heat transfer tubes 31 adjacent to each other at the closest positions. Therefore, the flow velocity of the second fluid L that has flowed into the first small flow path portion 45A and the second small flow path portion 45B further increases. Therefore, the heat transfer efficiency of the second fluid L via the flow path forming portion 40A increases as the second fluid L flows through the first small flow path portions 45A and the second small flow path portions 45B. As a result, the heat exchange efficiency between the first fluid H inside the heat transfer tube 31 and the second fluid L outside the heat transfer tube 31 can be further increased.

(3) A heat exchanger 100A to 100D according to a third aspect is the heat exchanger 100A to 100D described in (1) or (2) in which the flow path forming portion 40A to 40D includes a plurality of first protrusion portions 41 that protrude from an outer surface 32 of one heat transfer tube 31A of the two heat transfer tubes 31 adjacent to each other at the closest positions among the plurality of heat transfer tubes 31 toward the other heat transfer tube 31B to extend in the extension direction Da and are disposed at intervals in the circumferential direction Dc of the plurality of heat transfer tubes 31, and a plurality of second protrusion portions 42 that protrude from an outer surface 32 of the other heat transfer tube 31 toward the one heat transfer tube 31 to extend in the extension direction Da and are disposed at intervals in the circumferential direction Dc, and each of the first protrusion portions 41 and each of the second protrusion portions 42 are disposed to be shifted in the circumferential direction Dc when viewed from the extension direction Da.

Thus, a contact surface area where the second fluid L comes into contact with the flow path forming portion 40A can be ensured largely by the first protrusion portion 41 and the second protrusion portion 42 compared to a case where only any one of the first protrusion portion 41 and the second protrusion portion 42 is formed. As a result, the heat exchange efficiency between the first fluid H inside the heat transfer tube 31 and the second fluid L outside the heat transfer tube 31 can be further increased.

(4) A heat exchanger 100A according to a fourth aspect is the heat exchanger 100A described in (3), in which part of a tip 41s of the each of the first protrusion portions 41 and part of a tip 42s of the each of the second protrusion portions 42, which are adjacent to each other in the circumferential direction Dc are connected when viewed from the extension direction Da.

Thus, the cross-sectional area when viewed from the extension direction Da can be made small compared to a case where the first small flow path portion 45A and the second small flow path portion 45B are connected. Thus, it is possible to further increase the flow velocity of the second fluid L that has flowed into the first small flow path portion 45A and the second small flow path portion 45B.

(5) A heat exchanger 100B according to a fifth aspect is the heat exchanger 100B described in (3), in which the each of the first protrusion portions 41 and the each of the second protrusion portions 42, which are adjacent to each other in the circumferential direction Dc are spaced apart in the circumferential direction Dc when viewed from the extension direction Da.

As described above, since the first protrusion portion 41 and the second protrusion portion 42 are independent, the first protrusion portion 41 and the second protrusion portion 42 are easily formed.

(6) A heat exchanger 100C and 100D according to a sixth aspect is the heat exchanger 100C and 100D described in any one of (1) to (5), in which in the flow path forming portion 40C and 40D, a flow path cross-sectional area of each of the plurality of small flow path portions 45 when viewed from the extension direction Da is formed larger at a position closer to the discharge portion 22 than that at a position closer to the supply portion 21 in the extension direction Da.

Thus, the flow path cross-sectional area of the small flow path portion 45 when viewed from the extension direction Da at a position close to the discharge portion 22 can be increased. Therefore, a volume expansion of the second fluid L that has flowed from the supply portion 21 toward the discharge portion 22 can be allowed, and the flow velocity of the second fluid L can be increased at a position close to the discharge portion 22. As a result, the heat exchange efficiency between the first fluid H inside the heat transfer tube 31 and the second fluid L outside the heat transfer tube 31 can be increased.

(7) A heat exchanger 100C according to a seventh aspect is the heat exchanger 100C described in (6), in which at least some of the plurality of small flow path portions 45 merge with each other in a middle of the extension direction Da.

Thus, it is possible to easily form a structure in which the flow path cross-sectional area is increased in the middle of the extension direction Da.

(8) A heat exchanger 100D according to an eighth aspect is the heat exchanger 100D described in (6), in which in the plurality of small flow path portions 45D, a flow path cross-sectional area when viewed from the extension direction Da gradually increases from the supply portion 21 toward the discharge portion 22 in the extension direction Da.

Thus, an increase in volume of the second fluid L can be allowed, and the flow velocity of the second fluid L can be gradually increased. As a result, the heat exchange efficiency between the first fluid H inside the heat transfer tube 31 and the second fluid L outside the heat transfer tube 31 can be increased.

### EXPLANATION OF REFERENCES

10: Pipe
10c: Bent portion
10r: Flow path
11: Pipe main body
12: Elbow portion
13: Vane
20: Partition plate
20A: First partition plate
20B: Second partition plate
21: Supply portion
22: Discharge portion
30A, 30D: Core portion
30a: First end portion
30b: Second end portion
30c: Core intermediate portion
31, 31A, 31B, 31D: Heat transfer tube
31b: Top portion
31c: Central axis
31t: Top portion
32: Outer surface
38a, 38b: Gap
40A to 40D: Flow path forming portion
41: First protrusion portion
41s: Tip
42: Second protrusion portion
42s: Tip
45, 45D: Small flow path portion
45A: First small flow path portion
45B: Second small flow path portion
48A: First flow path region
48B: Second flow path region
100A to 100D: Heat exchanger
211: Supply portion main body
212: Supply port
221: Discharge portion main body
222: Discharge port
Da: Extension direction
Da1: One side
Da2: The other side
Dc: Circumferential direction
Dh: Horizontal direction
Ds: Tube diameter
Dt: Facing direction
Dv: Vertical direction
H: First fluid
L: Second fluid
Sc: Closed space

What is claimed is:

1. A heat exchanger comprising:
a pipe main body forming a flow path to which a first fluid is supplied;
a pair of partition plates that are spaced apart in an extension direction of the pipe main body, block part of the flow path in the extension direction, and define a closed space in part of the flow path;
a plurality of heat transfer tubes that have a tubular shape with both ends open, extend in the extension direction to penetrate the pair of partition plates, and are disposed side by side at intervals;
a supply portion configured to supply a second fluid from an outside of the pipe main body into the closed space;
a discharge portion that is spaced apart from the supply portion in the extension direction and configured to discharge the second fluid in the closed space to the outside of the pipe main body; and
a flow path forming portion that forms a plurality of small flow path portions among the plurality of heat transfer tubes that are adjacent to each other at closest positions in the plurality of heat transfer tubes,
wherein the second fluid flows between the plurality of heat transfer tubes in the closed space in a direction opposite to a flow direction of the first fluid, and
the plurality of small flow path portions are disposed at positions different from each other when viewed from a position where the discharge portion is disposed in the extension direction.

2. The heat exchanger according to claim 1, wherein the flow path forming portion forms, as the small flow path portions,
a first small flow path portion disposed at a position close to one heat transfer tube of two heat transfer tubes adjacent to each other at the closest positions among the plurality of heat transfer tubes, and
a second small flow path portion disposed at a position close to the other heat transfer tube of the two heat transfer tubes adjacent to each other at the closest positions and disposed at a position shifted in a circumferential direction of the plurality of heat transfer tubes with respect to the first small flow path portion when viewed from the extension direction.

3. The heat exchanger according to claim 1, wherein the flow path forming portion includes
a plurality of first protrusion portions that protrude from an outer surface of one heat transfer tube of two heat transfer tubes adjacent to each other at the closest positions among the plurality of heat transfer tubes toward the other heat transfer tube to extend in the extension direction and are disposed at intervals in a circumferential direction of the plurality of heat transfer tubes,
a plurality of second protrusion portions that protrude from an outer surface of the other heat transfer tube toward the one heat transfer tube to extend in the extension direction and are disposed at intervals in the circumferential direction, and
each of the plurality of first protrusion portions and each of the plurality of second protrusion portions are disposed to be shifted in the circumferential direction when viewed from the extension direction.

4. The heat exchanger according to claim 3, wherein part of a tip of the each of the plurality of first protrusion portions and part of a tip of the each of the plurality of second protrusion portions, which are adjacent to each other in the circumferential direction are connected to each other when viewed from the extension direction.

5. The heat exchanger according to claim 3, wherein the each of the plurality of first protrusion portions and the each of the plurality of second protrusion portions, which are adjacent to each other in the circumferential direction are spaced apart in the circumferential direction when viewed from the extension direction.

6. The heat exchanger according to claim 1, wherein in the flow path forming portion, a flow path cross-sectional area of each of the plurality of small flow path portions when viewed from the extension direction is formed larger at a position closer to the discharge portion than that at a position closer to the supply portion in the extension direction.

7. The heat exchanger according to claim 6, wherein at least some of the plurality of small flow path portions merge with each other in a middle of the extension direction.

8. The heat exchanger according to claim 6, wherein in the plurality of small flow path portions, a flow path cross-sectional area when viewed from the extension direction gradually increases from the supply portion toward the discharge portion in the extension direction.
